(19) United States
(12) Patent Application Publication
(10) Pub. No.: US 2024/0031368 A1
(43) Pub. Date: Jan. 25, 2024

(54) TECHNIQUES FOR DEFENDING AGAINST AUTHENTICATION ATTACKS USING COMPUTATIONAL LINGUISTICS

(71) Applicant: Okta, Inc., San Francisco, CA (US)

(72) Inventor: Garrett Scott McNamara, Cocoa, FL (US)

(21) Appl. No.: 17/814,732

(22) Filed: Jul. 25, 2022

(51) Int. Cl. H04L 9/40

(52) U.S. Cl. CPC H04L 63/101; H04L 63/105; H04L 63/083

(57) ABSTRACT

Methods, systems, and devices for discounting extensibility latency are described. A software platform may receive multiple requests from a source to access one or more resources. Each request may use one or more credentials. The software platform may determine that a deviation between at least one credential used by a previous request and at least one other credential used by a subsequent request satisfies a threshold. In some examples, the threshold may be based on the one or more resources. The software platform may restrict access to the one or more resources based on the deviation satisfying the threshold.

### FIELD OF TECHNOLOGY

The present disclosure relates generally to database systems and data processing, and more specifically to techniques for defending against authentication attacks using computational linguistics.

### SUMMARY

The described techniques relate to improved methods, systems, devices, and apparatuses that support techniques for defending against authentication attacks using computational linguistics. For example, the described techniques provide a framework for identifying a deviation between credentials. A software platform may receive multiple requests from a source that may use one or multiple credentials. The software platform may compare a credential associated with a previous request from the source to another credential associated with a subsequent request from the source. In some examples, based on the comparison, the software platform may determine whether a deviation between the credential associated with the previous request and the corresponding credential associated with the subsequent request satisfies a threshold. In some examples, the software platform may determine that the deviation satisfies the threshold and restrict requests from the source for access.

A method for managing access requests at a device is described. The method may include receiving, at a software platform of the device, a set of multiple requests from a source to access one or more resources, where each request of the set of multiple requests uses one or more credentials, determining that a deviation between at least one credential used by a previous request of the set of multiple requests and at least one other credential used by a subsequent request of the set of multiple requests satisfies a threshold, where the threshold is based on the one or more resources, and restricting access to the one or more resources based on the deviation satisfying the threshold.

An apparatus for managing access requests at a device is described. The apparatus may include a processor, memory coupled with the processor, and instructions stored in the memory. The instructions may be executable by the processor to cause the apparatus to receive, at a software platform of the device, a set of multiple requests from a source to access one or more resources, where each request of the set of multiple requests uses one or more credentials, determine that a deviation between at least one credential used by a previous request of the set of multiple requests and at least one other credential used by a subsequent request of the set of multiple requests satisfies a threshold, where the threshold is based on the one or more resources, and restrict access to the one or more resources based on the deviation satisfying the threshold.

Another apparatus for managing access requests at a device is described. The apparatus may include means for receiving, at a software platform of the device, a set of multiple requests from a source to access one or more resources, where each request of the set of multiple requests uses one or more credentials, means for determining that a deviation between at least one credential used by a previous request of the set of multiple requests and at least one other credential used by a subsequent request of the set of multiple requests satisfies a threshold, where the threshold is based on the one or more resources, and means for restricting access to the one or more resources based on the deviation satisfying the threshold.

A non-transitory computer-readable medium storing code for managing access requests at a device is described. The code may include instructions executable by a processor to receive, at a software platform of the device, a set of multiple requests from a source to access one or more resources, where each request of the set of multiple requests uses one or more credentials, determine that a deviation between at least one credential used by a previous request of the set of multiple requests and at least one other credential used by a subsequent request of the set of multiple requests satisfies a threshold, where the threshold is based on the one or more resources, and restrict access to the one or more resources based on the deviation satisfying the threshold.

Some examples of the method, apparatuses, and non-transitory computer-readable medium described herein may further include operations, features, means, or instructions for determining a quantity of operations to perform on the at least one credential used by the previous request to obtain the at least one other credential used by the subsequent request, where the deviation includes the quantity of operations.

In some examples of the method, apparatuses, and non-transitory computer-readable medium described herein, the at least one credential used by the previous request and the at least one other credential used by the subsequent request each include at least one sequence of elements and an operation of the quantity of operations corresponds to an element of a sequence of the at least one sequence of elements.

In some examples of the method, apparatuses, and non-transitory computer-readable medium described herein, determining that the deviation between the at least one credential used by the previous request and the at least one other credential used by the subsequent request satisfies the threshold may include operations, features, means, or instructions for determining that the deviation between a portion of the at least one credential used by the previous request and a corresponding portion of the at least one other credential used by the subsequent request satisfies the threshold.

In some examples of the method, apparatuses, and non-transitory computer-readable medium described herein, determining that the deviation between the at least one credential used by the previous request and the at least one other credential used by the subsequent request satisfies the threshold may include operations, features, means, or instructions for determining that the at least one other credential used by the subsequent request may be unassociated with a set of credentials corresponding to the at least one credential used by the previous request.

Some examples of the method, apparatuses, and non-transitory computer-readable medium described herein may further include operations, features, means, or instructions for determining that a feature flag associated with the threshold may be enabled for the source, where determining that the deviation between the at least one credential used by the previous request and the at least one other credential used by the subsequent request satisfies the threshold may be based on the feature flag being enabled.

In some examples of the method, apparatuses, and non-transitory computer-readable medium described herein, restricting access to the one or more resources may include operations, features, means, or instructions for transmitting a message responsive to the subsequent request that indicates, to the source, an authentication failure of the at least one other credential, where the message may be based on the deviation satisfying the threshold.

Some examples of the method, apparatuses, and non-transitory computer-readable medium described herein may further include operations, features, means, or instructions for transmitting a message that indicates, to a user of the software platform, a request to updated a credential, where the message may be based on the deviation satisfying the threshold, and where the credential includes the at least one credential used by the previous request or the at least one other credential used by the subsequent request.

Some examples of the method, apparatuses, and non-transitory computer-readable medium described herein may further include operations, features, means, or instructions for determining that a duration over which the device received the set of multiple requests from the source satisfies a request rate threshold, where restricting access to the one or more resources may be based on the duration satisfying the request rate threshold.

Some examples of the method, apparatuses, and non-transitory computer-readable medium described herein may further include operations, features, means, or instructions for determining that the previous request may be associated with an authentication success, where restricting access to the one or more resources may be based on receiving the subsequent request.

Some examples of the method, apparatuses, and non-transitory computer-readable medium described herein may further include operations, features, means, or instructions for storing, at the device, the at least one credential used by the previous request and the at least one other credential used by the subsequent request based on the deviation satisfying the threshold.

In some examples of the method, apparatuses, and non-transitory computer-readable medium described herein, the source includes a device associated with a device fingerprint or one or more devices associated with a same internet protocol address.

In some examples of the method, apparatuses, and non-transitory computer-readable medium described herein, the at least one credential used by the previous request and the at least one other credential used by the subsequent request each include one or both of a username and password.

### BACKGROUND

A software application may request a user to log into an account using authentication information, such as a combination of a username and a password. Users who have accounts for several different applications must therefore remember several different usernames and passwords. Additionally, or alternatively, the necessity of separately logging in to each application may impose a considerable burden on the user, who must enter usernames and passwords for each application used. In some cases, the user may use a software platform to help manage contacts or other identifying information associated with accounts for accessing software applications through login requests. However, for some use cases, conventional information management techniques may be deficient or sub-optimal in some current configurations.

### BRIEF DESCRIPTION OF THE DRAWINGS

FIG. 1 illustrates an example of a managing access requests system that supports techniques for defending against authentication attacks using computational linguistics in accordance with aspects of the present disclosure.

FIG. 2 illustrates an example of a block diagram that supports techniques for defending against authentication attacks using computational linguistics in accordance with aspects of the present disclosure.

FIGS. 3A and 3B each illustrate an example of a credential deviation diagram that supports techniques for defending against authentication attacks using computational linguistics in accordance with aspects of the present disclosure.

FIG. 4 illustrates an example of a process flow that supports techniques for defending against authentication attacks using computational linguistics in accordance with aspects of the present disclosure.

FIG. 5 shows a block diagram of an apparatus that supports techniques for defending against authentication attacks using computational linguistics in accordance with aspects of the present disclosure.

FIG. 6 shows a block diagram of a software platform that supports techniques for defending against authentication attacks using computational linguistics in accordance with aspects of the present disclosure.

FIG. 7 shows a diagram of a system including a device that supports techniques for defending against authentication attacks using computational linguistics in accordance with aspects of the present disclosure.

FIGS. 8 and 9 show flowcharts illustrating methods that support techniques for defending against authentication attacks using computational linguistics in accordance with aspects of the present disclosure.

### DETAILED DESCRIPTION

A user may use a software platform to manage identifying information associated with the user. The identifying information may include personal information (e.g., name, social security number, driver license number), contact information (e.g., home address, telephone number, email address), payment information (e.g., credit card number, bank information), account information (e.g., credentials), or any combination thereof. As described herein, a credential may refer to a username or a password, among other examples. In some examples, the user may use the software platform to access resources associated with a request (e.g., a login request, a network protocol request). For example, the user may use the software platform to authenticate and authorize access to resources as part of a login request. In some examples, the software platform may authenticate and authorize access to the resources based on one or more credentials, such as a combination of a username and password, used as part of the request. The software platform may be stored locally at a device of the user (e.g., a client device). Additionally, or alternatively, the software platform may be implemented as a cloud platform and the user may access the software platform via a cloud client.

In some examples, a software platforms may experience malicious attacks in which a user (e.g., an attacker) may attempt to gain unauthorized access to resources associated with the software platform. To reduce the likelihood of the attacker gaining unauthorized access, the software platform may use one or more defense mechanisms. For example, the software platform may receive multiple requests from a user for access to the resources. In some examples, the multiple requests may use a username (e.g., a same username) and multiple passwords (e.g., different passwords). In such examples, if a quantity of requests that use invalid passwords (e.g., and a same username) satisfies a threshold, the software platform may identify the requests as a malicious attack and restrict access to a user associated with the username. In some other examples, the multiple request may use multiple (e.g., different) usernames and multiple passwords. In such an example, the multiple requests may be unidentified as a malicious attack.

Various aspects of the present disclosure relate to techniques for defending against authentication attacks using computational linguistics, and more specifically, to techniques for identifying a deviation between credentials. For example, a software platform may receive multiple requests from a source (e.g., one or more users associated with a same internet protocol (IP) address or a same device) that may each use one or multiple credentials (e.g., a username, a password, or both). In such an example, the software platform may compare a credential (e.g., a username, a password) associated with a previous request from the source to another credential (e.g., another username, another password) associated with a subsequent request from the source. In some examples, based on the comparison, the software platform may determine whether a deviation between the credential associated with the previous request and the corresponding credential associated with the subsequent request satisfies a threshold. The threshold may be dynamic and based on the resources (or the software platform). In some examples, the deviation may correspond to an edit distance (e.g., a quantity of single-character edits) between the credentials (e.g., the credential associated with the previous request and the corresponding credentials associated with the subsequent request satisfies a threshold) or an edit distance between a portion of the credentials. Additionally, or alternatively, the deviation may correspond to whether the subsequent credential may be unassociated with a set of credentials corresponding to the credential used by the previous request. In some examples, the software platform may determine that the deviation satisfies the threshold. In such examples, the software platform may restrict requests from the source for access.

Aspects of the subject matter described herein may be implemented to realize one or more of the following potential advantages. For example, the techniques employed by the software platform may provide benefits and enhancements to defense mechanisms for authentication attacks. Aspects of the disclosure are initially described in the context of a system for distributed computing. Aspects of the disclosure are also described in the context of a block diagram, credential deviation diagrams, and a process flow. Aspects of the disclosure are further illustrated by and described with reference to apparatus diagrams, system diagrams, and flowcharts that relate to techniques for defending against authentication attacks using computational linguistics.

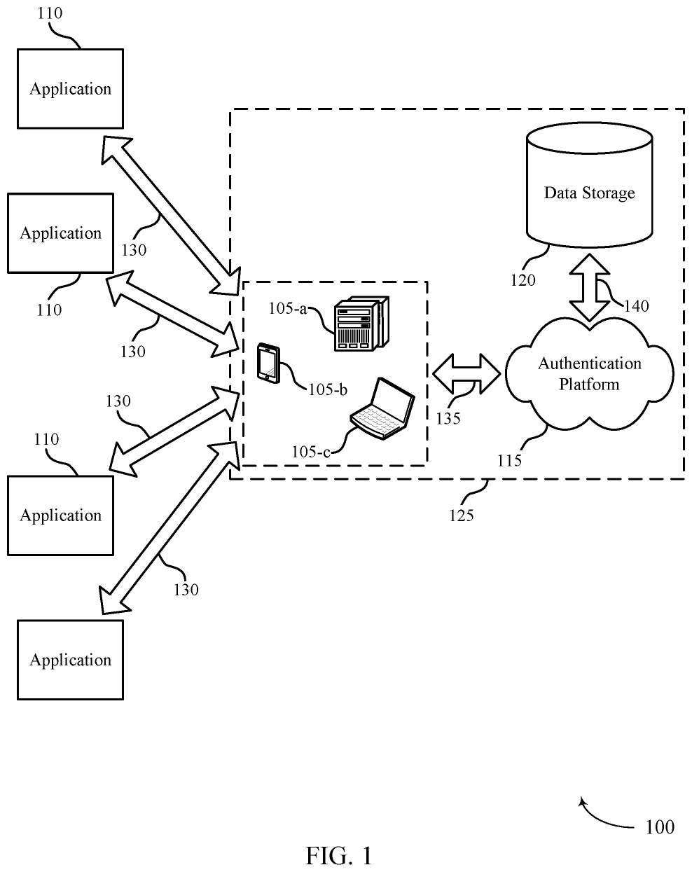

FIG. 1 illustrates an example of a system 100 for distributed computing (e.g., cloud computing) that supports techniques for defending against authentication attacks using computational linguistics in accordance with various aspects of the present disclosure. The system 100 includes client devices 105, applications 110, authentication platform 115, and data storage 120. Authentication platform 115 may be an example of a public or private cloud network. A client device 105 may access authentication platform 115 over network connection 135. The network may implement transmission control protocol and internet protocol (TCP/IP), such as the Internet, or may implement other network protocols. A client device 105 may be an example of a user device, such as a server (e.g., client device 105-a), a smartphone (e.g., client device 105-b), or a laptop (e.g., client device 105-c). In other examples, a client device 105 may be a desktop computer, a tablet, or another computing device or system capable of generating, analyzing, transmitting, or receiving communications. In some examples, a client device 105 may be operated by a user that is part of a business, an enterprise, a non-profit, a startup, or any other organization type.

A client device 105 may interact with multiple applications 110 via one or more interactions 130. The interactions 130 may include digital communications, application programming interface (API) calls, hypertext transfer protocol (HTTP) messages, or any other interaction between a client device 105 and an application 110. Data may be associated with the interactions 130. A client device 105 may access authentication platform 115 to store, manage, and process the data associated with the interactions 130. In some examples, the client device 105 may have an associated security or permission level. A client device 105 may have access to some applications, data, and database information within authentication platform 115 based on the associated security or permission level, and may not have access to others.

Applications 110 may interact with the client device 105 via email, web, text messages, or any other suitable form of interaction. The interaction 130 may be a business-to-business (B2B) interaction or a business-to-consumer (B2C) interaction. An application 110 may also be referred to as a customer, a client, a website, or some other suitable terminology. In some examples, the application 110 may be an example of a server, a node, a compute cluster, or any other type of computing system, component, or environment. In some examples, the application 110 may be operated by a user or group of users.

Authentication platform 115 may offer cloud-based services to the client devices 105, the applications 110, or both. In some examples, authentication platform 115 may support database system such as a multi-tenant database system. In such cases, authentication platform 115 may serve multiple client devices 105 with a single instance of software. However, other types of systems may be implemented, including—but not limited to—client-server systems, mobile device systems, and mobile network systems. Authentication platform 115 may receive data associated with interactions 130 from the client device 105 over network connection 135, and may store and analyze the data. In some examples, authentication platform 115 may receive data directly from an interaction 130 between an application 110 and the client device 105. In some examples, the client device 105 may develop applications to run on authentication platform 115. Authentication platform 115 may be implemented using remote servers. In some examples, the remote servers may be examples of data storage 120.

Data storage 120 may include multiple servers. The multiple servers may be used for data storage, management, and processing. Data storage 120 may receive data from authentication platform 115 via connection 140, or directly from the client device 105 or an interaction 130 between an application 110 and the client device 105. Data storage 120 may utilize multiple redundancies for security purposes. In some examples, the data stored at data storage 120 may be backed up by copies of the data at multiple locations.

Subsystem 125 may include client devices 105, authentication platform 115, and data storage 120. In some examples, data processing may occur at any of the components of subsystem 125, or at a combination of these components. In some examples, servers may perform the data processing. The servers may be a client device 105 or located at data storage 120.

In some examples, the subsystem 125 (e.g., a software platform) may experience malicious attacks in which in which a user (e.g., an attacker associated with a client device 105) may attempt to gain unauthorized access to resources associated with the subsystem 125. To reduce the likelihood of the attacker gaining unauthorized access, the subsystem 125 may use one or more defense mechanisms (e.g., authentication mechanisms). For example, the subsystem 125 may experience credential stuffing attacks in which the user may attack target authentication mechanisms (e.g., at the subsystem 125) to gain access to resources (e.g., accounts). In some examples of credential stuffing, the subsystem 125 may receive multiple requests from the user (e.g., a same user) that use multiple credentials (e.g., multiple username and password combinations). In some examples, credential stuffing attacks may reduce an effectiveness of authentication mechanisms that utilize password attempt thresholds. For example, the user may use a quantity of passwords per username that fails to satisfy a threshold (e.g., a lockout threshold) established as part of the authentication mechanisms. For example, the subsystem 125 may receive a request from the user to access resources and may authorize access to the resources based on one or more credentials (e.g., a username and password used as part of the request). To reduce the likelihood of the user gaining unauthorized access to the resources, the subsystem 125 may restrict access to the resources if a quantity of requests received from the user that use a same username and one or more invalid passwords satisfies the threshold. In some examples, however, if the requests use multiple usernames, such as during a credential stuffing attack, the quantity of requests may fail to satisfy the threshold. As such, credential stuffing attacks may reduce the effectiveness of detection mechanisms that may rely on usernames to track requests that use invalid credentials (e.g., authentication failures).

As described herein, the subsystem 125 (e.g., a software platform associated with a client device 105, or an authentication platform 115, or both) may be configured to determine a deviation between credentials used across multiple requests. For example, the subsystem 125 may support one or more techniques for defending against authentication attacks (e.g., defense mechanisms) using computational linguistics. In some examples, the subsystem 125 may identify malicious attacks based on the determined deviation. The deviation may, in some examples, correspond to an edit distance (e.g., a quantity of single-character edits) between two or more credentials or an edit distance between a portion of the two or more credentials. Additionally, or alternatively, the deviation may correspond to whether a credential use as part of a request (e.g., of the multiple requests) may be unassociated with a set of credentials (e.g., a databased of credentials stored at the subsystem 125) corresponding to another credential used as part of another request (e.g., of the multiple requests).

For example, the subsystem 125 may receive multiple request from a source (e.g., one or more users associated with a client device 105) for access to one or more resources. In some examples, each request may use one or more credentials (e.g., a username and password). The subsystem 125 may compare a credential (e.g., a username) associated with a previous request from the source to a corresponding credential (e.g., another username) associated with a subsequent request from the source. The subsystem 125 may determine (e.g., based on the comparison) that a deviation between the credential associated with the previous request and the corresponding credential associated with the subsequent request satisfies a threshold. In such an example, the subsystem 125 may restrict requests from the source for access (e.g., may block the source).

It should be appreciated by a person skilled in the art that one or more aspects of the disclosure may be implemented in a system 100 to, additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

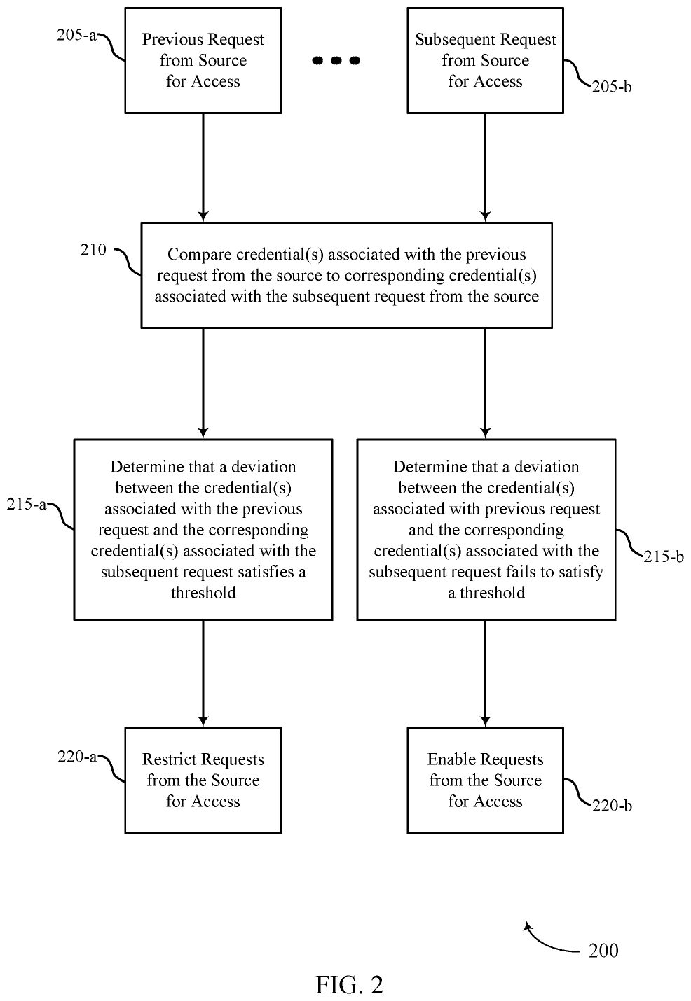

FIG. 2 illustrates an example of a block diagram 200 that supports techniques for defending against authentication attacks using computational linguistics in accordance with aspects of the present disclosure. In some examples, the block diagram 200 may implement or be implemented by aspects of the system 100. For example, the block diagram 200 may be implemented at a software platform, which may be an example of subsystem 125 as described with reference to FIG. 1.

In some examples, techniques for defending against authentication attacks using computational linguistics, as described herein, may support one or more methods for detecting credential stuffing attacks against internal and external (e.g., customer-facing) authentication platforms. In some examples, credential stuffing may be an example of an attack against authentication mechanisms to gain access to multiple accounts (e.g., as many accounts as possible). For example, as described herein, credential stuffing may refer to attacks in which the software platform may receive multiple requests from a source (e.g., a same source) that use multiple credentials (e.g., multiple username and password combinations). As an illustrative example, a credential stuffing attack may include requests that use username and password combinations in accordance with the following Table 1:

TABLE 1

| USERNAME | PASSWORD |
|---|---|
| Admin | Admin |
| Test | Tester |
| Joe | JoelsCool123 |
| Jane | ILoveCofee! |

In some examples, credential stuffing may leverage lists of credentials (e.g., lists of username and password combinations) obtained from one or more breaches (e.g., to one or more Internet services, to one or more software platforms). For example, a breach (e.g., a successful attempt to gain unauthorized access to resources) of a software platform may enable a source to obtain credentials (e.g., may divulge credentials to a source) associated with accounts of the software platform. In some examples, such credentials may be re-used (e.g., by the respective users of the accounts) for other accounts (e.g., of other software platform, such as software platforms used for banking). In some examples, credential stuffing attacks may exploit credential re-use (e.g., human nature to re-use credentials) across software platforms. In such examples, other software platforms (e.g., software platforms that the source attempts to gain access to using the obtained credentials) may be susceptible to the source (e.g., an attacker) gaining unauthorized access to accounts within the other software platforms. Additionally, or alternatively, the other software platforms may be susceptible to the source gaining unauthorized access to the accounts irrespective of the other software platforms being vulnerable or exploited (e.g., irrespective of the other software platforms being breached themselves). Additionally, or alternatively, in some examples, system administrators (e.g., operators) of the other software platforms may bear responsibility for security of the accounts (e.g., within the respective software platforms) irrespective of being breached.

Credential stuffing attacks may be problematic (e.g., concerning) for software platforms used to manage contacts or other identifying information associated with accounts of the software platforms. Additionally, or alternatively, credential stuffing attacks may be problematic for other software platforms that may be used in one or more security industries. For example, credential stuffing may lead to increased security risks (e.g., may be more difficult to defend against) relative to other types of attacks that may rely on brute force or dictionary password mechanisms (e.g., brute force attacks or dictionary password attacks), among other examples. As described herein, a brute force attack may refer to attacks in which the software platform may receive multiple request that use relatively similar credentials (e.g., password, password1, password2, password3). Additionally, or alternatively, dictionary attacks may refer attacks in which the source may receive multiple requests that use relatively common credentials (e.g., statistically common passwords, such as 123456, qwerty, password, abc123, iloveyou). In some examples, statistically common passwords may be examples of passwords that have an increased likelihood of being used, for example due to an increased likelihood of being determined by a user (e.g., remembered). As an illustrative example, a brute force attack may include requests that use username and password combinations in accordance with the following Table 2:

TABLE 2

| USERNAME | PASSWORD |
|---|---|
| Admin | Password |
| Admin | Password1 |
| Admin | Password123 |
| Admin | ABC123 |

Additionally or alternatively, techniques for defending against authentication attacks (e.g., detection mechanisms) using computational linguistics, as described herein, may provide defense against username enumeration and password spraying attacks, among other possible examples. Password spraying (e.g., and credential stuffing) may be used (e.g., by an attacker) to avoid account lockout mechanisms (e.g., policies). For example, a password spraying attack may include the use (e.g., re-use) of a relatively small quantity of passwords (e.g., one or relatively few passwords that may be commonly used) with a relatively large quantity of usernames. Username enumeration may be an example of an attempt to obtain (e.g., develop one or more lists of) usernames (e.g., valid usernames) associated with a software platform (e.g., on a server or application). In some examples, the obtained usernames may be used for subsequent (e.g., additional) attacks.

In some examples, a source (e.g., an attacker) may use credential stuffing and password spraying attacks against systems that utilize password attempt thresholds (e.g., have account lockout policies). That is, in some examples of a credential stuffing attack or a password spraying attack (or both), the source may use a quantity of passwords per username (e.g., per account) that fails to satisfy a threshold (e.g., a lockout threshold) established by the system administrators. For example, a software platform may receive a request (e.g., a login request) from the source to access one or more resources (e.g., via the software platform) and the software platform may authenticate and authorize (e.g., grant, allow) access to the one or more resources based on one or more credentials (e.g., a username and password used as part of the request).

In some examples, to prevent unauthorized access to resources, the software platform may restrict access to the resources if a quantity of requests (e.g., invalid requests, requests that use one or more invalid credentials) from the source (e.g., from a same source) satisfies a threshold. For example, the software platform may receive multiple requests from the source that use one or more invalid credentials (e.g., an invalid combination of a username and password). In some examples (e.g., during brute force attacks, during dictionary attacks), the software platform may receive a first quantity of requests that use a username (e.g., a same username) and multiple passwords (e.g., multiple invalid passwords). In such examples, the software platform may restrict access to the source (e.g., a user associated with the username) if the first quantity of requests satisfies (e.g., exceeds, is greater than or equal to) the threshold. That is, the software platform may restrict access to a user associated with the username if a quantity of password attempts by the user satisfies the thresholds.

In some examples, however, the source may adapt (e.g., evolve) an attack mechanism to decrease the effectiveness of (e.g., avoid) lockout mechanisms. For example, the source may attempt to gain unauthorized access to the resources by submitting multiple requests using multiple (e.g., different) combinations of usernames and passwords. That is, the software platform may receive a second quantity of requests (e.g., a same quantity of requests as the first quantity of requests) that use multiple usernames and multiple passwords (e.g., multiple username and password combinations). In such an example, the software platform may determine that the second quantity of requests fails to satisfy the threshold (e.g., based on the use of multiple usernames). That is, credential stuffing attacks (e.g., and password spraying attacks) may decrease the effectiveness of some detection mechanisms, such as detection mechanisms that may rely on usernames (e.g., accounts) to track (e.g., “bin” or “bucket”) authentication failures (e.g., failed password attempts).

In some examples, an attacker conducting a brute force attack may use (e.g., guess, select) multiple passwords per account (e.g., per username associated with an account), which may lead to the account becoming locked (e.g., due to the multiple passwords being invalid, or exceeding a threshold, or both). However, an attacker conducting a credential stuffing attack may use a password (e.g., a different password) for each account (e.g., for each of the multiple accounts). As such, a quantity of failed password attempts that may occur during the credential stuffing attack (e.g., against the account) may fail to exceed one. Accordingly, defense mechanisms (e.g., lockout mechanisms) for brute force attacks may have a decreased effectiveness against credential stuffing attacks.

In some examples, techniques for defending against authentication attacks using computational linguistics, as described herein, may provide one or more security enhancements (e.g., defense mechanisms) for software platforms. For example, such techniques may provide one or more enhancements to defense mechanisms for authentication attacks by using computational linguistics and, more specifically, the concept of edit distance. In some examples, edit distance may refer to a means for quantifying a deviation between two strings (e.g., words, sequences of elements). For example, edit distance may be used to determine how dissimilar two strings may be (e.g., with respect to one another) by summing (e.g., counting) a quantity (e.g., a minimum quantity or an otherwise suitable quantity) of operations that may be used to transform a string (e.g., a username, a password) into another string (e.g., another username, another password).

Some edit distances may find applications in natural language processing, such as natural language processing in which automatic spelling correction may be used to determine candidate corrections for a misspelled word. In some examples, such natural language processing may determine candidate corrections for a misspelled word by selecting words from a dictionary that have a reduced (e.g., relatively low) edit distance to the misspelled word. As such, some techniques for defending against authentication attacks using computational linguistics, may be viewed as an alternative to (e.g., the opposite of) autocorrect mechanisms, in which an increased (e.g., relatively high) edit distance, such as between two usernames, may trigger the software platform to restrict access. In some examples, a metric associated with edit distance (e.g., within the family of edit distance) may include a Levenshtein distance. For example, the Levenshtein distance between two words may correspond to a quantity (e.g., a minimum quantity or an otherwise suitable quantity) of character edits (e.g., single-character edits, such as insertions, deletions, or substitutions) used to obtain a string from another string (e.g., used to change a word into another word).

In some examples, an edit distance (e.g., a Levenshtein distance) may be used to identify whether an invalid credential is used as part of a an attack (e.g., a malicious attack) or due to an unintended error (e.g., due to a forgetful user or an unintended typo). For example, an unintended error may lead to a relatively low edit distance (e.g., an edit distance that fails to satisfy a threshold, a Levenshtein Distance of about 1 or 2), while a malicious attack (e.g., a credential stuffing attack) may lead to a relatively high edit distance (e.g., an edit distance that satisfies a threshold, a Levenshtein Distance of about 13). That is, credential stuffing attacks may lead to an increased edit distance relative to an edit distance that may be associated with an unintended error (e.g., due to the forgetful user or the unintended typo). As such, the software platform (e.g., an administrator of the software platform) may select (e.g., set, determine) a value of a threshold (e.g., a deviation threshold, a detection threshold) between an edit distance that may be associated with malicious attacks and another edit distance that may be associated with unintended errors. In some examples, the threshold may be selected (e.g., changed) dynamically, for example based on security or permission levels associated with the software platform, users of the software platform, or resources associated with a request, among other possible examples.

As illustrated in the example of FIG. 2, the software platform may receive multiple request from a source for access to one or more resources (e.g., associated with the software platform or one or more other software platforms). For example, at 205-a the software platform may receive a previous request (e.g., a first request or some other previous request) from the source for access to one or more resources. Additionally, or alternatively, 205-b, the software platform may receive a subsequent request for access to one or more resources (or one or more other resources). In some examples, the subsequent request may correspond to a next request or another request received at the software platform (or transmitted from the source) subsequent to (e.g., after) the previous request received at 205-a.

At 210, the software platform may compare one or more credentials associated with the previous request from the source (e.g., received at 205-a) to one or more corresponding credentials associated with the subsequent request from the source (e.g., received at 205-b). For example, the software platform may compare a username or password (or both) used as part of the previous request (e.g., for access to the one or more resources) with a username or password (or both) used as part of the subsequent request (e.g., for access to the one or more resources).

At 215-a, the software platform may determine (e.g., based on the comparison performed at 210) that a deviation between the one or more credentials associated with the previous request and the one or more corresponding credentials associated with the subsequent request satisfies a threshold. In such an example, at 220-a, the software platform may restrict requests from the source for access (e.g., may restrict access to the one or more resources, may block the source). Additionally, or alternatively, at 215-b, the software platform may determine (e.g., based on the comparison performed at 210) that a deviation between the one or more credentials associated with previous request and the one or more corresponding credentials associated with the subsequent request fails to satisfy a threshold. In such an example, at 220-b, the software platform may enable requests from the source (e.g., may enable access to the one or more resources, may refrain from blocking the source).

In some examples, the deviation may correspond to an edit distance (e.g., a Levenshtein distance). For example, the deviation may correspond to an edit distance between the one or more credentials (or a portion of the one or more credentials) associated with the previous request and the one or more credentials (or a portion of the one or more credentials) associated with the subsequent request. Additionally, or alternatively, the deviation may correspond to the one or more credentials associated with the subsequent request being unassociated with a set of other credentials (e.g., a databased of credentials) that may correspond to the one or more credentials associated with the previous request. That is, the software platform may determine that the one or more credentials associated with the subsequent request are not included in a set of strings (e.g., words, names) related to (e.g., that are relatively similar to, that are alternatives to) the one or more credentials associated with the previous request. In some examples, restricting requests from the source based on the deviation satisfying the threshold may lead to increased security at the software platform, among other possible benefits.

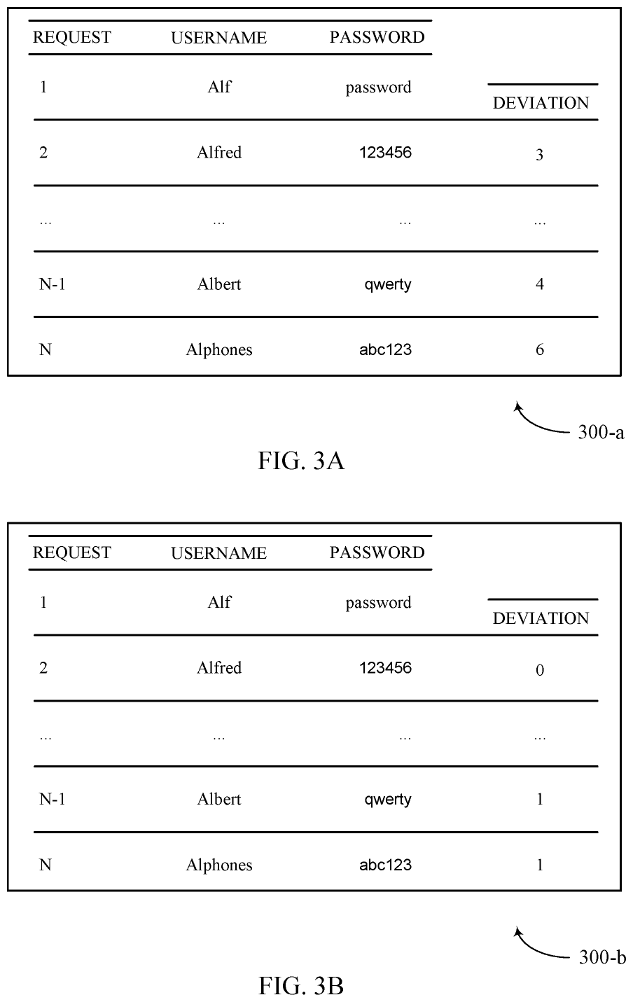

FIGS. 3A and 3B illustrate examples of credential deviation diagrams 300 (e.g., a credential deviation diagram 300-a and a credential deviation diagram 300-b) that supports techniques for defending against authentication attacks using computational linguistics in accordance with aspects of the present disclosure. In some examples, the credential deviation diagram 300 may implement or be implemented by aspects of the system 100 and the block diagram 200. For example, the credential deviation diagram 300 may be implemented at a software platform, which may be an example of subsystem 125 as described with reference to FIG. 1.

Some techniques for defending against authentication attacks using computational linguistics, as described herein, may provide one or more security enhancements (e.g., defense mechanisms) for software platforms. In some examples, such techniques may support one or more defense mechanisms that use natural language processing and usernames (or one or more other credentials). For example, a user (e.g., person, source) attempting to gain access to resources (e.g., transmitting multiple requests) using multiple (e.g., different) usernames may lead to an increased security risk (e.g., suspicion) relative to a security risk associated with the use of multiple passwords. For instance, a frequency at which usernames associated with software platforms change may be reduced relative to a frequency at which passwords may change. For example, usernames may be static, while passwords may change dynamically. As such, a user may have an increased likelihood of remembering a username (e.g., relative to a password).

Additionally, or alternatively, usernames associated with some software platforms may be inflexible (e.g., constrained) relative to passwords, which may be unconstrained or relatively less constrained. As such, a quantity (e.g., pool) of possible usernames that may be associated with a user (e.g., and a respective software platform) may be reduced relative to a quantity (e.g., pool) of possible passwords. For example, a user may select a password based on some password guidance that may indicate for relatively frequent password changes (e.g., routine password rotation without re-use), while a username may be unchanged. As such, the quantity of passwords (e.g., historical passwords) associated with a user may increase (e.g., over time), while the quantity of usernames associated with the user may be static (e.g., may be unchanging, may change relatively infrequently).

Additionally, or alternatively, a deviation (e.g., difference) between possible usernames (e.g., associated with a user) may be small relative to a deviation (e.g., difference) between possible passwords. For example, as illustrated in the example of FIG. 3A, a password (e.g., password, 123456, qwerty, abc123) may include any combination of numbers, letters, or characters, while a username (e.g., Alf, Alfred, Albert, Alphonse) may be associated with an identity of the user. That is, some software platforms may enable users with control (e.g., full control, partial control, increased control) over password selection for an account associated with the software platform, while usernames may be constrained. For example, a username may be constrained by one or more parameters, such as a particular format (e.g., firstname.lastname) that may be associated with the software platform or an organization, among other possible examples.

As illustrated in the example of FIG. 3A, a software platform may identify a credential stuffing attack based on a deviation of a username (e.g., or another credential) across multiple (e.g., at least two) requests. For example, the software platform may receive a quantity of requests (N) from a source (e.g., a same source, a same IP address, a same device). In some examples, the software platform may determine whether a deviation (e.g., edit distance) between a previous request (e.g., a request with an index of 1) and a subsequent request (e.g., a request with an index of 2, N−1, or N) satisfies a threshold (e.g., about 5). For example, the software platform may determine that the edit distance between the previous request and the request with an index of 2 (e.g., an edit distance with a value of 3) fails to satisfy the threshold (e.g., fails to exceed the threshold, is less than the threshold). In such an example, the software platform may refrain from restricting access to the source. Additionally, or alternatively, the software platform may determine that the edit distance between the previous request and the request with an index of N (e.g., an edit distance with a value of 6) satisfies the threshold (e.g., exceeds the threshold, is greater than the threshold). In such an example, the software platform may determine to restrict access to the source.

As illustrated in the example of FIG. 3B, the software platform may identify a credential stuffing attack based on a deviation (e.g., edit distance) of a portion of a username (e.g., or another credential) across multiple (e.g., at least two) requests. For example, the software platform may use word stems, such as “Samantha” which may stem from “Sam”. In such an example (e.g., without relying on background context) the software platform may determine (e.g., account for) whether two usernames (e.g., words) have a common portion of elements (e.g., letters, numbers, characters). In some examples, using word stems may enable the software platform to reduce a likelihood of falsely identifying a malicious attack (e.g., a credential stuffing attack). That is, the software platform may reduce the likelihood of detecting false positives of malicious behavior (e.g., may reduce a penalty associated with a relatively high Levenshtein Distance between usernames). In some examples, the portion of the username (e.g., which may be used to determine the deviation) may correspond to a quantity of elements of the username. In some examples, the quantity of elements may exceed (e.g., be greater than) one element. For example, using a single element of a username (e.g., a first letter of the username) to identify a malicious attack may lead to an increased likelihood of the software platform failing to detect a malicious attack (e.g., may lead to an increased quantity of unrelated usernames being undetected).

In the example of FIG. 3B, the software platform may determine whether an edit distance between a portion (e.g., a prefix, a first three elements) of a username across multiple (e.g., at least two) requests satisfies a threshold. For example, the software platform may receive a quantity of requests (N) from a source (e.g., a same source, a same IP address, a same device). In some examples, the software platform may determine whether a deviation (e.g., edit distance) between a previous request (e.g., a request with an index of 1) and a subsequent request (e.g., a request with an index of 2, N−1, or N) satisfies a threshold (e.g., about 1). For example, the software platform may determine that the edit distance between the previous request and the request with an index of 2 (e.g., an edit distance with a value of 0) fails to satisfy the threshold (e.g., fails to exceed the threshold, is less than the threshold). In such an example, the software platform may refrain from restricting access to the source. Additionally, or alternatively, the software platform may determine that the edit distance between the previous request and the request with an index of N−1 (e.g., an edit distance with a value of 1) satisfies the threshold (e.g., is equal to the threshold). In such an example, the software platform may determine to restrict access to the source.

In some examples, the deviation may correspond to (e.g., consider) whether the usernames (or other credentials) included in a request (e.g., being attempted) are related. For instance, the username “Sam” may correspond to a portion (e.g., a relatively common version) of the username “Samantha”. In such an example, while an edit distance (e.g., the Levenshtein Distance) between “Sam” and “Samantha” may be relatively large (e.g., about 5) the software platform (e.g., and people) may determine that “Sam” and “Samantha” are related (e.g., associated). In such an example, the software platform may determine that the deviation between the username “Sam” and the username “Samantha” fails to exceed a threshold.

In some examples, the software platform may use set of credentials (e.g., a database, a names database, a databased of related names) to identify whether credentials are related (e.g., whether a deviation between two credentials satisfies a threshold). In such examples, the databased may include multiple (e.g., different) alternatives of a username. For example, a database corresponding to the username “Sam” may include the username “Samantha.” Additionally, or alternatively, the databased may include (e.g., cover a case in which) alternative usernames may be dissimilar, but may be known alternatives (e.g., known to a person, known to the software platform). For example, a databased corresponding to the username “Richard” may include the username “Dick.” In some examples, using a databased to determine whether the deviation satisfies a threshold may increase the likelihood of detecting a malicious attack that may use credentials with a same portion of elements (e.g., a same prefix). That is, using a database may reduce the likelihood of an attacker exploiting username prefixes. For example, a username “Al” may correspond to an alternative username for “Alfred,” “Albert,” “Alphonse,” “Alphons,” “Allen,” “Allyson,” among other examples. In such an example, while the username “Al” may correspond to an alternative (e.g., a valid alternative to the username “Alfred,” the username “Alfred” may correspond to an invalid alternative to the username “Albert.” Additionally, or alternatively, while the username “Alf” may correspond to an alternative (e.g., a valid alternative” to the username “Alfred,” the username “Alf” may correspond to an invalid alternative to the username “Albert.” As such, receiving a previous request that uses the username “Alf” and a subsequent request that uses the username “Albert” may be considered malicious activity.

For example, as illustrated in the example of FIG. 3B, the software platform may reference a database (e.g., a database of related names) to determine whether the deviation between the previous request (e.g., the request with an index of 1) and the subsequent requests (e.g., the request with an index of 2, the request with an index of N−1, the request with an index of N) satisfies a threshold. In such an example, the deviation may be binary, such that the threshold may correspond to a value of 1. For example, in response to receiving the subsequent request with an index of 2, the software platform may reference a database corresponding to the username “Alf” to determine whether the username “Alfred” is associated with the username “Alf” (e.g., included in the database corresponding to the username “Alf”). In some examples, the software platform may determine (e.g., based on referencing the database) that the username “Alfred” is associated with the username “Alf.” In such an example, the deviation may correspond to a value of 0 and, as such, may fail to satisfy the threshold. Additionally, or alternatively, in response to receiving the subsequent request with an index of N−1, the software platform may reference a database corresponding to the username “Alf” to determine whether the username “Albert” is associated with the username “Alf” (e.g., included in the database corresponding to the username “Alf”). In some examples, the software platform may determine (e.g., based on referencing the database) that the username “Albert” is unassociated with the username “Alf.” In such an example, the deviation may correspond to a value of 1 and, as such, may satisfy the threshold.

In some examples, the source (e.g., an attacker) may sort credentials to reduce the deviation between credentials used with previous and subsequent requests. For example, the source may sort the credentials alphabetically. In such an example, a quantity of possible credentials (e.g., usernames associated with valid accounts of the software platform) may be insufficient to reduce the deviation between requests (e.g., attempted usernames), such that the threshold may fail to be satisfied. That is, the quantity of possible credentials may be reduced, such as to introduce gaps between related usernames. In such an example, the gaps may result in a failure of the threshold to be satisfied. In some examples, the attacker uses (e.g., injects) an increased quantity of invalid usernames, such as to supplement gaps between valid usernames to reduce the deviation (e.g., to avoid satisfying the threshold). In such examples, however, an overhead associated with the attack (e.g., time, effort, and quantity of request) may be increased, thereby discouraging the source from pursuing the attack.

Additionally, or alternatively, the necessity of trying an increased quantity of invalid usernames may increases the likelihood of an attack being detected by another detection mechanism (e.g., may lead to increased noise of the attack). As such, the software platform may implement techniques for defending against authentication attacks using computational linguistics, as described herein, with one or more other detection mechanisms (e.g., complementary detection mechanisms). For example, the software platform may restrict access based on whether a duration over which multiple requests are received (e.g., from a same source) satisfies another threshold (e.g., a request rate threshold). Additionally, or alternatively, a likelihood of a user transmitting a subsequent request in response to receiving an indication of an authentication success may be relatively low and, as such, the software platform may restrict access based on whether a previous request is associated with an authentication success.

Additionally or alternatively, to protect against sorting (e.g., alphabetical sorting) the software platform may implement a lookback feature in which the software platform may compare a previous request (e.g., a first guess) to one or multiple subsequent requests. For example, the software platform may determine whether requests from the source use credentials (e.g., usernames) that may be determined (e.g., at the source) through iterating over related usernames. That is, the software platform may determine whether subsequent requests use credentials related to a previous request. As an illustrative example, a previous request may use the username “Bob,” while subsequent requests may use the usernames “Bob1,” “Bob2,” and “Bob3,” respectively. In such an example, while an edit distance (e.g., a Levenshtein Distance) between the previous request and the subsequent requests may be relatively low (e.g., may correspond to a value of 1), the software platform may identify (e.g., through use of the lookback feature) a pattern associated with the multiple subsequent requests (e.g., may determine that the usernames are being tried iteratively). In such an example, the software platform may identify the multiple subsequent requests as malicious activity (e.g., as a credential stuffing attack).

In some examples, the multiple subsequent requests may progress beyond a valid alternative to the previous request. For example, the previous request may use the username “Bob,” while the subsequent requests may use the usernames “Rob,” “Rod,” “Ron,” “Von,” and “Van,” respectively. In such an example, while an edit distance (e.g., a Levenshtein Distance) between the previous request and the subsequent request that uses the username “Rob” may be relatively low (e.g., may correspond to a value of 1), an edit distance between the previous request and the subsequent request that uses the username “Van” may be relatively high (e.g., may correspond to a value of 3). In such an example, the software platform may identify the multiple subsequent requests as malicious activity (e.g., as a credential stuffing attack). Additionally, or alternatively, sorting credentials (e.g., usernames, passwords) based on the editing distance (e.g., to reduce the editing distance) may result in a deviation of the credentials from an alphabetic order. For example, alphabetically, the username “Roy” may follow the username “Ron,” however sorting the set of usernames “Rob,” “Rod,” “Ron,” “Von,” and “Van,” based on editing distance may lead to the username “Roy” preceding the username “Ron.”

In some examples, the software platform may attribute requests to authenticated (e.g., pre-authenticated) attackers. For example, determining whether a deviation between credentials used with a previous request and credentials used with a subsequent request may occur prior to authentication (e.g., authentication of a distributed denial-of-service (DDoS) attack) and may implement one or more tracking mechanisms (e.g., robust pre-authentication tracking mechanism). In some examples, the software platform may use device fingerprinting or anonymous sessions (or both).

In some examples, multiple users (e.g., a set of users) of a software platform (e.g., customers) may be associated with a same source (e.g., a common browser, a common IP address, a same device). In such an example, multiple request from the same source may lead to a false positive. As such, the software platform may use a feature flag to determine whether a set of users may be associated with the same source. For example, the software platform may determine whether a deviation between a credential used by the previous request and a credential used by the subsequent request satisfies the threshold based on the feature flag being enabled.

Although the examples of FIGS. 3A and 3B illustrate a credential stuffing attack, it is to be understood that detection mechanisms described herein can also defend against username enumeration and password spraying attacks, among other possible examples of attacks, and the examples described herein should not be considered limiting to the scope covered by the claims or the disclosure. Additionally, or alternatively, although the examples of FIGS. 3A and 3B illustrate a deviation between usernames, it is to be understood that the detection mechanisms described herein can also be applied to a password or a combination of a username and password, among other possible examples of credentials, and the examples described herein should not be considered limiting to the scope covered by the claims or the disclosure. Moreover, although the examples of FIGS. 3A and 3B illustrate a deviation of subsequent requests relative to a request with an index of 1, it is to be understood that a deviation may be determined relative to any previous request and the examples described herein should not be considered limiting to the scope covered by the claims or the disclosure.

In some examples, techniques for defending against authentication attacks using computational linguistics, as described herein, may provide detection of a malicious attack (e.g., a credential stuffing attack, a password spraying attack) relatively quickly. For example, in accordance with the techniques for defending against authentication attacks using computation linguistics may enable the software platform to identify a malicious attack based on a reduced quantity of attempts (e.g., about 2 attempts), while other defense mechanisms for authentication attacks may rely on maintaining relatively large lists of credentials (e.g., obtained through breaches). Additionally, or alternatively, in some examples, attackers may avoid attribution by changing (e.g., regularly changing) attributes, which may reduce the effectiveness of the other defense mechanisms that may rely on maintaining lists of credentials.

In some examples, techniques for defending against authentication attacks using computational linguistics, as described herein, may provide reduced overhead (e.g., a minimal overhead or otherwise suitable quantity of state storage overhead). For example, the overhead may correspond to a previously attempted username. Additionally, or alternatively, such techniques may provide for a dynamic (e.g., flexible, customizable) detection threshold. For example, techniques for defending against authentication attacks using computational linguistics, as described herein, may enable a software platform (or administrator of the software platform) to select a threshold (e.g., dynamically), for example based on a Levenshtein Distance value, among other examples. Additionally, or alternatively, such techniques may be used within some organizations, such as organizations that may use a username format (e.g., firstname.lastname). In some examples, techniques for defending against authentication attacks using computational linguistics, as described herein, may provide defense against malicious attacks, which may occur over a relatively long duration (e.g., low-and-slow attack) such as to avoid exceeding a rate of request threshold.

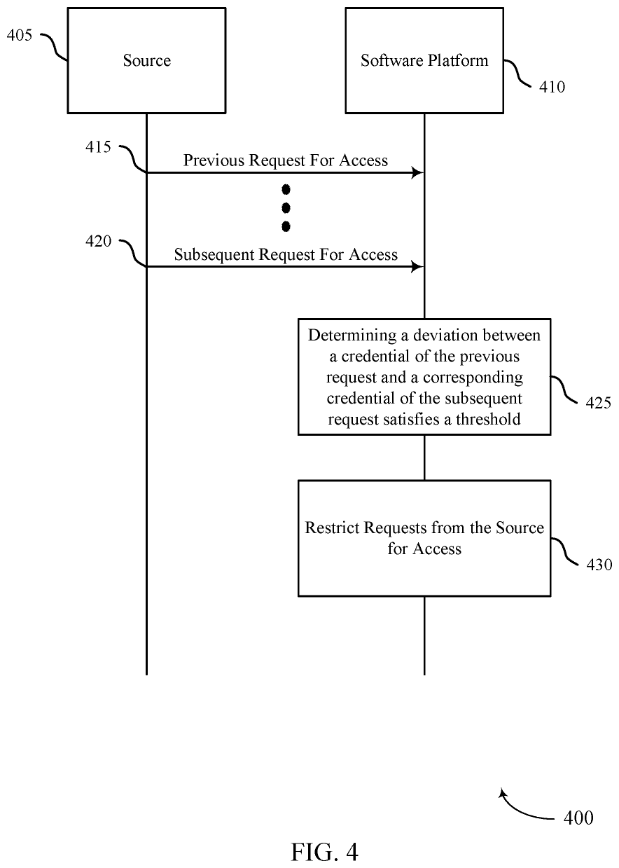

FIG. 4 illustrates an example of a process flow 400 that supports techniques for defending against authentication attacks using computational linguistics in accordance with aspects of the present disclosure. In some examples, the process flow 400 may implement or be implemented by aspects of the system 100, the block diagram 200, and the credential deviation diagram 300. For example, the process flow 400 may illustrate operations between a software platform 410 and a source 405, which may be examples of a subsystem 125 and a client device 105, respectively, as described with reference to FIG. 1. The process flow 400 may be implemented at the software platform 410, the source 405, or both. In the following description of the process flow 400, the information communicated between the software platform 410 and the source 405 may be performed in different orders or at different times than shown. Additionally, or alternatively, some operations may be omitted from the process flow 400 and other operations may be added to the process flow 400.

As illustrated in the example of FIG. 4, the software platform 410 may support techniques for defending against authentication attacks (e.g., a defense mechanism) using computational linguistics. For example, the software platform 410 may receive multiple requests from a source 405 to access one or more resources (e.g., for access to one or more resources). In such an example, each request (e.g., of the multiple requests) may use one or more credentials. For example, at 415, the software platform may receive a previous request for access from the source 405 that may use one or more credentials (e.g., a username, a password). At 420, the software platform may receive a subsequent request for access from the source 405 that may use one or more other credentials (e.g., another username, another password).

At 425, the software platform 410 may determining that a deviation between a credential of the previous request (e.g., the username, the password) and a corresponding credential (e.g., the other username, the other password) of the subsequent request satisfies a threshold. The threshold may be an example of a threshold as described throughout the present disclosure, include with reference to FIGS. 1 through 3. For example, the threshold may be based on the one or more resources. At 430, in response to the determination at 425, the software platform 410 may restrict requests from the source 405 for access. That is, the software platform 410 may restrict access to the one or more resources based on the deviation satisfying the threshold.

In some examples, determining that the deviation satisfies the threshold (e.g., at 425) may be based on whether the credential of the previous request and the corresponding credential of the subsequent request correspond to valid (e.g., existing) accounts associated with the software platform 410. For example, a user may have an increased likelihood of remembering a username (e.g., relative to a password) and, as such, the software platform 410 may identify an attempt to authenticate with a non-existing account (e.g., the previous request, the subsequent request, or both) as a malicious attack. That is, attempts to authenticate with non-existent accounts may be associated with a credential stuffing attack (e.g., bot behavior) and unassociated with a user of an existing account (e.g., a forgetful user).

In some examples, based on identifying that a request (e.g., the previous request, the subsequent request, or both) corresponds to an attempt to authenticate with a non-existing account, the software platform 410 may increment an authentication failure counter by in increased value. For example, if the software platform identifies an authentication failure associated with a request (e.g., based on the request using one or more invalid credentials), the software platform 410 may increment the authentication failure counter by a value of 1. Additionally, or alternatively, if the software platform identifies an authentication failure associated with another request (e.g., based on the request using one or more invalid credentials) and that the other request corresponds to an attempt to authenticate with a non-existing account, the software platform 410 may increment the counter by a value of 2 (e.g., or another suitable value greater than 1). In such an example, requests that may use invalid credentials (e.g., authentication attempts for non-existent accounts) may lead to the authentication failure counter approaching a threshold relatively more quickly than requests that may use valid credentials.

In some examples, restricting access to the one or more resources (e.g., at 430) may be based on whether the previous request is associated with successful authentication (e.g., whether the software platform 410 receives continued requests from the source 405 after successful authentication). For example, a user may refrain from transmitting requests (e.g., trying different credentials) subsequent to a successful authentication attempt. Additionally, or alternatively, an attacker (e.g., a bot, the source 405) may transmit requests (e.g., may iterate through a list of credentials to report valid credentials to a command and control (C2) server) irrespective of whether a request (e.g., an authentication attempt) is successful. For example, the software platform 410 may determine that the previous request (e.g., received at 415) may be associated with an authentication success and, as such, may restrict access to the one or more resources in response to receiving the subsequent request (e.g., at 420).

In some examples, identifying requests received subsequent to a successful authentication attempt as a malicious attack may reduce the likelihood of a source (e.g., a bot) attempting multiple credentials and reporting valid credentials. Additionally, or alternatively, identifying requests received subsequent to a successful authentication attempt as a malicious attack may reduce the likelihood of the source 405 (e.g., a bot) performing actions (e.g., a series of actions, such as internal information scraping) on the account after the source 405 encounters a successful authentication. For example, by identifying requests received subsequent to a successful authentication attempt as a malicious attack, the software platform 410 may restrict subsequent requests (e.g., block attempts) from the source 405 (e.g., the particular bot).

In some examples, techniques for defending against authentication attacks (e.g., defense mechanisms) using computational linguistics, as described herein, may provide a signal (e.g., an additional signal) for one or more detections. For example, the software platform 410 may integrate the defense mechanisms with credential lists (e.g., lists of credentials obtained from breaches) and other intelligence mechanisms. Additionally or alternatively, in response to detecting a malicious attack (e.g., a credential stuffing attack), the software platform 410 may supply supplemental credentials to lists of credentials from known breaches. That is, in some examples, implementing the defense mechanisms at the software platform 410 may provide a signal (e.g., an additional signal) for one or more attack detections.

For example, the software platform 410 may store credentials used by the previous request (e.g., received at 415) and other credentials used by the subsequent request (e.g., received at 420) based on the deviation satisfying the threshold. That is, if the software platform 410 detects a malicious attack (e.g., a credential stuffing attack), the software platform may store the credentials (e.g., rather than restricting requests from the source 405). In some examples, by storing credentials used as part of a malicious attack, the software platform may collect credentials that may have been obtained via a breach (e.g., of another software platform) and supply supplemental credentials to the lists of credentials from known breaches. That is, storing credentials used as part of a malicious attack may enable the software platform 410 to collect additional credentials (e.g., without having to actively source zero-day lists of credential breaches).

In some examples, a zero-day credential list may be an example of a zero-day vulnerability patch. For example, a zero-day credential list may correspond to a list of credentials obtained at a first time instance in which a breach occurs. For instance, a second time instance in which credentials obtained from a breach may be incorporated into one or more defenses may be delayed relative to the first time instance in which the breach may occur. As such, during a duration between the first time instance and the second time instance (e.g., the intervening time) the source 405 (e.g., an attacker) may transmit requests to the software platform 410 that use credentials obtained from the breach (e.g., may attempt to use credentials) and such credentials may be unassociated with a list of credentials stored at the software platform 410 (e.g., a list of credentials associated with breaches). In some examples, by storing credentials used by the previous request and other credentials used by the subsequent request, the software platform 410 may supplement (e.g., patch) the list of credentials (e.g., stored at the software platform 410). Additionally or alternatively, based on the deviation satisfying the threshold, the software platform may store identity information (e.g., an IP address) associated with the source.

In some examples, the software platform 410 may supply supplemental credentials to lists of credentials from known breaches by refraining from notifying the source 405 of a detected attack. For example, if the software platform 410 identifies a malicious attack and receives a subsequent request that uses one or more valid credentials, the software platform 410 may refrain from transmitting (e.g., returning) a notification of an authentication success (e.g., an affirmative response). In some examples, the software platform 410 may transmit a message responsive to the subsequent request (e.g., received at 420) that indicates, to the source 405, an authentication failure of the other credentials based on the deviation satisfying the threshold. Additionally or alternatively, in such examples, the software platform 410 may refrain from performing backend lookups on collected credentials. Additionally, or alternatively, the software platform may perform backend lookups to determine whether the source (e.g., the attacker) may be in possession of valid credentials (e.g., obtained from a breach). In some examples, in response to refraining from performing the backend lookups, the software platform 410 may pad a latency reduction, such that a timing difference between examples in which the software platform 410 performs backend lookups, and examples in which the software platform 410 refrains from performing backend lookups, may be reduced (e.g., may fail to be perceived by the attacker).

In some examples, techniques for defending against authentication attacks (e.g., defense mechanisms) using computational linguistics, as described herein, may provide increased visibility into an increasing quantity of authentication attempts. For example, such detection mechanisms may provide increased visibility into authentication attempts across an increased quantity of customers. Additionally or alternatively, techniques for defense mechanisms using computational linguistics, as described herein, may provide for per-customer breach notifications (e.g., a per-customer breach notification service). For example, the software platform 410 may notify users that may be associated with credentials used as part of a malicious attack (e.g., or obtained elsewhere, such as during a breach of another software platform). That is, in response to identifying a credential stuffing attack, the software platform 410 may return a false negative to the source 405 (e.g., in responses to subsequent requests, in response to subsequent authentication attempts). For example, if one or more valid credentials are used with a request, the software platform 410 may perform authentication lookups and transmit a notification to a user associated with the credentials (e.g., the victim) to update the respective credential. For example, the software platform 410 may transmit a password reset request (e.g., email) and restrict access to an account associated with the user (e.g., lock the corresponding account, such as until the password has been reset). That is, the software platform 410 may transmit a message that indicates, to the user of the software platform 410, a request to updated the credential based on the deviation satisfying the threshold.

In some examples, by increasing visibility into authentication attempts, the software platform 410 may provide one or more enhancements to password management techniques. For example, the software platform may extend security (e.g., a protective reach) beyond services known to (e.g., stored by) the user. Additionally, or alternatively, the software platform 410 may provide one or more defenses (e.g., a breach service) for users (e.g., customer) that may re-used passwords (e.g., irrespective of whether the breach service is known to a password manager of the user).

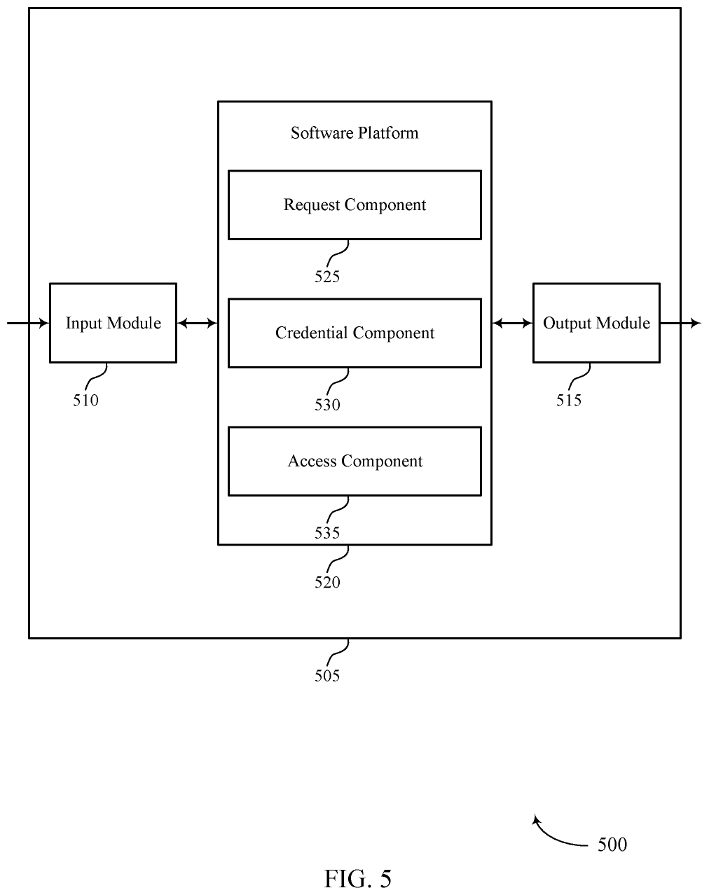

FIG. 5 shows a block diagram 500 of a device 505 that supports techniques for defending against authentication attacks using computational linguistics in accordance with aspects of the present disclosure. The device 505 may include an input module 510, an output module 515, and a software platform 520. The device 505 may also include a processor. Each of these components may be in communication with one another (e.g., via one or more buses).

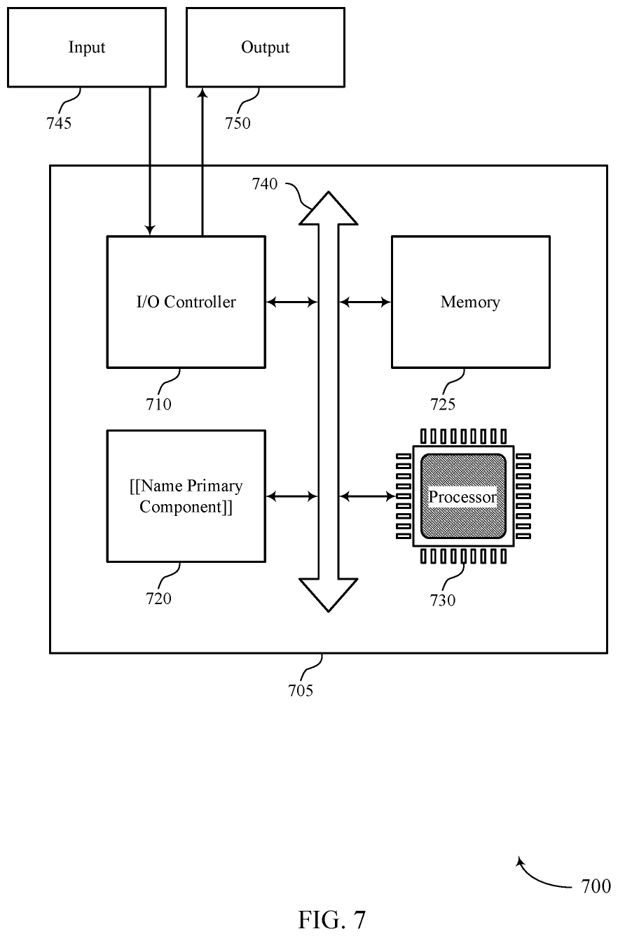

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the software platform 520 to support techniques for defending against authentication attacks using computational linguistics. In some cases, the input module 510 may be a component of an I/O controller 710 as described with reference to FIG. 7.

The output module 515 may manage output signals for the device 505. For example, the output module 515 may receive signals from other components of the device 505, such as the software platform 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the software platform 520 may include a request component 525, a credential component 530, an access component 535, or any combination thereof. In some examples, the software platform 520, or various components thereof, may be configured to perform various operations (e.g., receiving, monitoring, transmitting) using or otherwise in cooperation with the input module 510, the output module 515, or both. For example, the software platform 520 may receive information from the input module 510, send information to the output module 515, or be integrated in combination with the input module 510, the output module 515, or both to receive information, transmit information, or perform various other operations as described herein.

The software platform 520 may support managing access requests at a device in accordance with examples as disclosed herein. The request component 525 may be configured as or otherwise support a means for receiving, at a software platform of the device, a set of multiple requests from a source to access one or more resources, where each request of the set of multiple requests uses one or more credentials. The credential component 530 may be configured as or otherwise support a means for determining that a deviation between at least one credential used by a previous request of the set of multiple requests and at least one other credential used by a subsequent request of the set of multiple requests satisfies a threshold, where the threshold is based on the one or more resources. The access component 535 may be configured as or otherwise support a means for restricting access to the one or more resources based on the deviation satisfying the threshold.

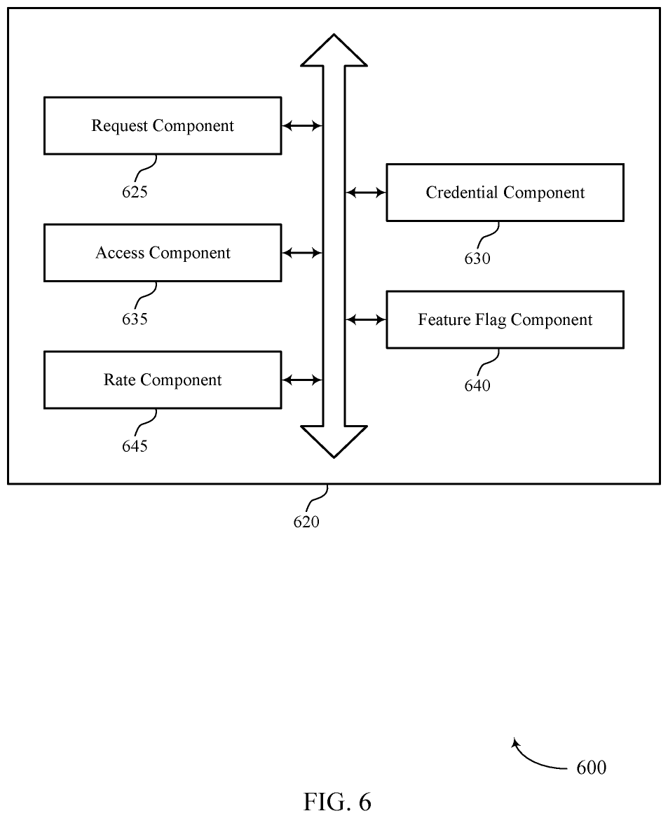

FIG. 6 shows a block diagram 600 of a software platform 620 that supports techniques for defending against authentication attacks using computational linguistics in accordance with aspects of the present disclosure. The software platform 620 may be an example of aspects of a software platform or a software platform 520, or both, as described herein. The software platform 620, or various components thereof, may be an example of means for performing various aspects of techniques for defending against authentication attacks using computational linguistics as described herein. For example, the software platform 620 may include a request component 625, a credential component 630, an access component 635, a feature flag component 640, a rate component 645, or any combination thereof. Each of these components may communicate, directly or indirectly, with one another (e.g., via one or more buses).

The software platform 620 may support managing access requests at a device in accordance with examples as disclosed herein. The request component 625 may be configured as or otherwise support a means for receiving, at a software platform of the device, a set of multiple requests from a source to access one or more resources, where each request of the set of multiple requests uses one or more credentials. The credential component 630 may be configured as or otherwise support a means for determining that a deviation between at least one credential used by a previous request of the set of multiple requests and at least one other credential used by a subsequent request of the set of multiple requests satisfies a threshold, where the threshold is based on the one or more resources. The access component 635 may be configured as or otherwise support a means for restricting access to the one or more resources based on the deviation satisfying the threshold.

In some examples, the credential component 630 may be configured as or otherwise support a means for determining a quantity of operations to perform on the at least one credential used by the previous request to obtain the at least one other credential used by the subsequent request, where the deviation includes the quantity of operations.

In some examples, the at least one credential used by the previous request and the at least one other credential used by the subsequent request each include at least one sequence of elements. In some examples, an operation of the quantity of operations corresponds to an element of a sequence of the at least one sequence of elements.

In some examples, to support determining that the deviation between the at least one credential used by the previous request and the at least one other credential used by the subsequent request satisfies the threshold, the credential component 630 may be configured as or otherwise support a means for determining that the deviation between a portion of the at least one credential used by the previous request and a corresponding portion of the at least one other credential used by the subsequent request satisfies the threshold.

In some examples, to support determining that the deviation between the at least one credential used by the previous request and the at least one other credential used by the subsequent request satisfies the threshold, the credential component 630 may be configured as or otherwise support a means for determining that the at least one other credential used by the subsequent request is unassociated with a set of credentials corresponding to the at least one credential used by the previous request.

In some examples, the feature flag component 640 may be configured as or otherwise support a means for determining that a feature flag associated with the threshold is enabled for the source, where determining that the deviation between the at least one credential used by the previous request and the at least one other credential used by the subsequent request satisfies the threshold is based on the feature flag being enabled.

In some examples, to support restricting access to the one or more resources, the access component 635 may be configured as or otherwise support a means for transmitting a message responsive to the subsequent request that indicates, to the source, an authentication failure of the at least one other credential, where the message is based on the deviation satisfying the threshold.

In some examples, the access component 635 may be configured as or otherwise support a means for transmitting a message that indicates, to a user of the software platform, a request to updated a credential, where the message is based on the deviation satisfying the threshold, and where the credential includes the at least one credential used by the previous request or the at least one other credential used by the subsequent request.

In some examples, the rate component 645 may be configured as or otherwise support a means for determining that a duration over which the device received the set of multiple requests from the source satisfies a request rate threshold, where restricting access to the one or more resources is based on the duration satisfying the request rate threshold.

In some examples, the access component 635 may be configured as or otherwise support a means for determining that the previous request is associated with an authentication success, where restricting access to the one or more resources is based on receiving the subsequent request.

In some examples, the credential component 630 may be configured as or otherwise support a means for storing, at the device, the at least one credential used by the previous request and the at least one other credential used by the subsequent request based on the deviation satisfying the threshold.

In some examples, the source includes a device associated with a device fingerprint or one or more devices associated with a same internet protocol address.

In some examples, the at least one credential used by the previous request and the at least one other credential used by the subsequent request each include one or both of a username and password.

FIG. 7 shows a diagram of a system 700 including a device 705 that supports techniques for defending against authentication attacks using computational linguistics in accordance with aspects of the present disclosure. The device 705 may be an example of or include the components of a device 505 as described herein. The device 705 may include components for bi-directional data communications including components for transmitting and receiving communications, such as a software platform 720, an I/O controller 710, a memory 725, and a processor 730. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting techniques for defending against authentication attacks using computational linguistics).

The software platform 720 may support managing access requests at a device in accordance with examples as disclosed herein. For example, the software platform 720 may be configured as or otherwise support a means for receiving, at a software platform of the device, a set of multiple requests from a source to access one or more resources, where each request of the set of multiple requests uses one or more credentials. The software platform 720 may be configured as or otherwise support a means for determining that a deviation between at least one credential used by a previous request of the set of multiple requests and at least one other credential used by a subsequent request of the set of multiple requests satisfies a threshold, where the threshold is based on the one or more resources. The software platform 720 may be configured as or otherwise support a means for restricting access to the one or more resources based on the deviation satisfying the threshold.

By including or configuring the software platform 720 in accordance with examples as described herein, the device 705 may support techniques for improved authentication attack detection, improved security, reduced latency, improved user experience related to reduced processing, and improved coordination between devices.

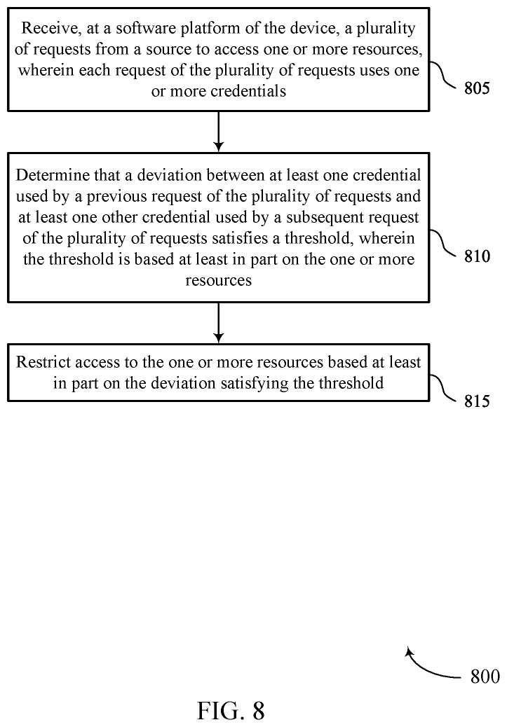

FIG. 8 shows a flowchart illustrating a method 800 that supports techniques for defending against authentication attacks using computational linguistics in accordance with aspects of the present disclosure. The operations of the method 800 may be implemented by a device or its components as described herein. For example, the operations of the method 800 may be performed by a device as described with reference to FIGS. 1 through 7. In some examples, a device may execute a set of instructions to control the functional elements of the device to perform the described functions. Additionally, or alternatively, the device may perform aspects of the described functions using special-purpose hardware.

At 805, the method may include receiving, at a software platform of the device, a set of multiple requests from a source to access one or more resources, where each request of the set of multiple requests uses one or more credentials. The operations of 805 may be performed in accordance with examples as disclosed herein. In some examples, aspects of the operations of 805 may be performed by a request component 625 as described with reference to FIG. 6.

At 810, the method may include determining that a deviation between at least one credential used by a previous request of the set of multiple requests and at least one other credential used by a subsequent request of the set of multiple requests satisfies a threshold, where the threshold is based on the one or more resources. The operations of 810 may be performed in accordance with examples as disclosed herein. In some examples, aspects of the operations of 810 may be performed by a credential component 630 as described with reference to FIG. 6.

At 815, the method may include restricting access to the one or more resources based on the deviation satisfying the threshold. The operations of 815 may be performed in accordance with examples as disclosed herein. In some examples, aspects of the operations of 815 may be performed by an access component 635 as described with reference to FIG. 6.

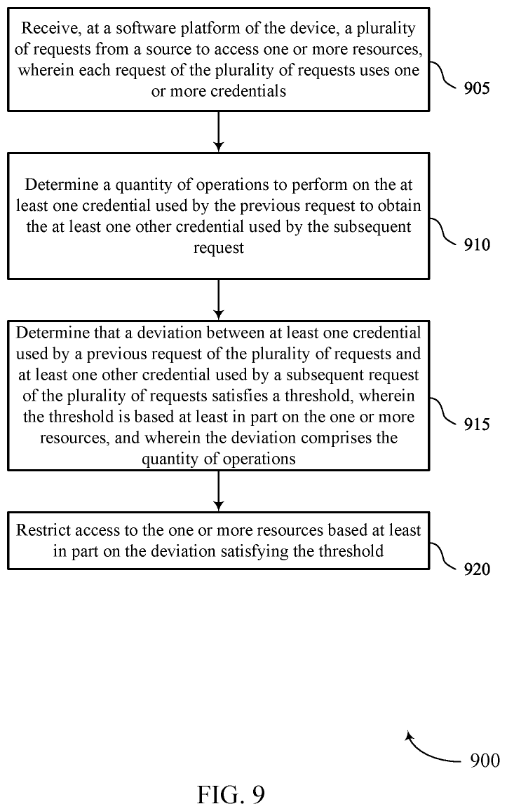

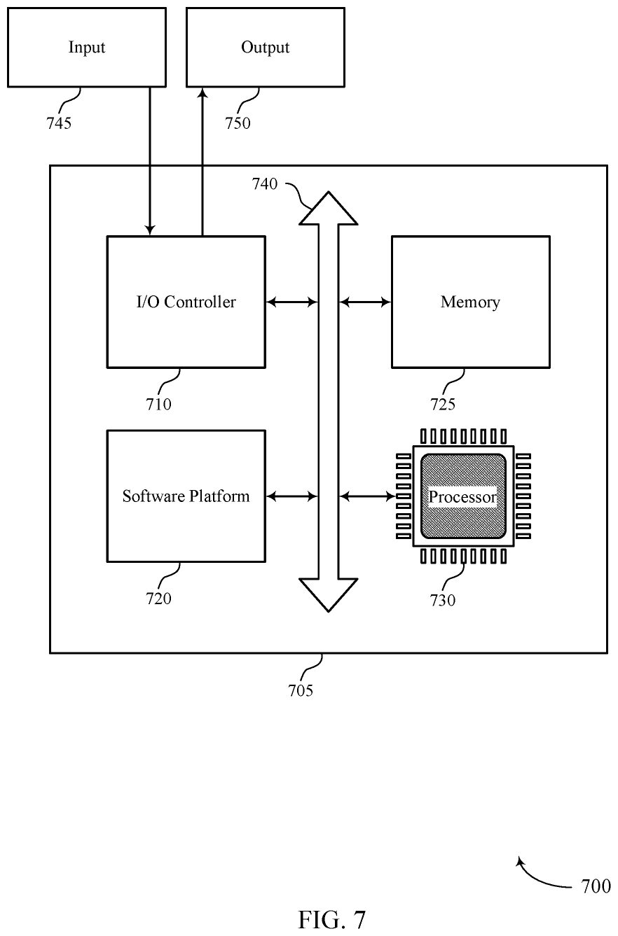

FIG. 9 shows a flowchart illustrating a method 900 that supports techniques for defending against authentication attacks using computational linguistics in accordance with aspects of the present disclosure. The operations of the method 900 may be implemented by a device or its components as described herein. For example, the operations of the method 900 may be performed by a device as described with reference to FIGS. 1 through 7. In some examples, a device may execute a set of instructions to control the functional elements of the device to perform the described functions. Additionally, or alternatively, the device may perform aspects of the described functions using special-purpose hardware.

At 905, the method may include receiving, at a software platform of the device, a set of multiple requests from a source to access one or more resources, where each request of the set of multiple requests uses one or more credentials. The operations of 905 may be performed in accordance with examples as disclosed herein. In some examples, aspects of the operations of 905 may be performed by a request component 625 as described with reference to FIG. 6.

At 910, the method may include determining a quantity of operations to perform on the at least one credential used by the previous request to obtain the at least one other credential used by the subsequent request. The operations of 910 may be performed in accordance with examples as disclosed herein. In some examples, aspects of the operations of 910 may be performed by a credential component 630 as described with reference to FIG. 6.

At 915, the method may include determining that a deviation between at least one credential used by a previous request of the set of multiple requests and at least one other credential used by a subsequent request of the set of multiple requests satisfies a threshold, where the threshold is based on the one or more resources, and where the deviation includes the quantity of operations. The operations of 915 may be performed in accordance with examples as disclosed herein. In some examples, aspects of the operations of 915 may be performed by a credential component 630 as described with reference to FIG. 6.

At 920, the method may include restricting access to the one or more resources based on the deviation satisfying the threshold. The operations of 920 may be performed in accordance with examples as disclosed herein. In some examples, aspects of the operations of 920 may be performed by an access component 635 as described with reference to FIG. 6.

A method for managing access requests at a device is described. The method may include receiving, at a software platform of the device, a set of multiple requests from a source to access one or more resources, where each request of the set of multiple requests uses one or more credentials, determining that a deviation between at least one credential used by a previous request of the set of multiple requests and at least one other credential used by a subsequent request of the set of multiple requests satisfies a threshold, where the threshold is based on the one or more resources, and restricting access to the one or more resources based on the deviation satisfying the threshold.

An apparatus for managing access requests at a device is described. The apparatus may include a processor, memory coupled with the processor, and instructions stored in the memory. The instructions may be executable by the processor to cause the apparatus to receive, at a software platform of the device, a set of multiple requests from a source to access one or more resources, where each request of the set of multiple requests uses one or more credentials, determine that a deviation between at least one credential used by a previous request of the set of multiple requests and at least one other credential used by a subsequent request of the set of multiple requests satisfies a threshold, where the threshold is based on the one or more resources, and restrict access to the one or more resources based on the deviation satisfying the threshold.

Another apparatus for managing access requests at a device is described. The apparatus may include means for receiving, at a software platform of the device, a set of multiple requests from a source to access one or more resources, where each request of the set of multiple requests uses one or more credentials, means for determining that a deviation between at least one credential used by a previous request of the set of multiple requests and at least one other credential used by a subsequent request of the set of multiple requests satisfies a threshold, where the threshold is based on the one or more resources, and means for restricting access to the one or more resources based on the deviation satisfying the threshold.

A non-transitory computer-readable medium storing code for managing access requests at a device is described. The code may include instructions executable by a processor to receive, at a software platform of the device, a set of multiple requests from a source to access one or more resources, where each request of the set of multiple requests uses one or more credentials, determine that a deviation between at least one credential used by a previous request of the set of multiple requests and at least one other credential used by a subsequent request of the set of multiple requests satisfies a threshold, where the threshold is based on the one or more resources, and restrict access to the one or more resources based on the deviation satisfying the threshold.

Some examples of the method, apparatuses, and non-transitory computer-readable medium described herein may further include operations, features, means, or instructions for determining a quantity of operations to perform on the at least one credential used by the previous request to obtain the at least one other credential used by the subsequent request, where the deviation includes the quantity of operations.

In some examples of the method, apparatuses, and non-transitory computer-readable medium described herein, the at least one credential used by the previous request and the at least one other credential used by the subsequent request each include at least one sequence of elements and an operation of the quantity of operations corresponds to an element of a sequence of the at least one sequence of elements.

In some examples of the method, apparatuses, and non-transitory computer-readable medium described herein, determining that the deviation between the at least one credential used by the previous request and the at least one other credential used by the subsequent request satisfies the threshold may include operations, features, means, or instructions for determining that the deviation between a portion of the at least one credential used by the previous request and a corresponding portion of the at least one other credential used by the subsequent request satisfies the threshold.

In some examples of the method, apparatuses, and non-transitory computer-readable medium described herein, determining that the deviation between the at least one credential used by the previous request and the at least one other credential used by the subsequent request satisfies the threshold may include operations, features, means, or instructions for determining that the at least one other credential used by the subsequent request may be unassociated with a set of credentials corresponding to the at least one credential used by the previous request.

Some examples of the method, apparatuses, and non-transitory computer-readable medium described herein may further include operations, features, means, or instructions for determining that a feature flag associated with the threshold may be enabled for the source, where determining that the deviation between the at least one credential used by the previous request and the at least one other credential used by the subsequent request satisfies the threshold may be based on the feature flag being enabled.

In some examples of the method, apparatuses, and non-transitory computer-readable medium described herein, restricting access to the one or more resources may include operations, features, means, or instructions for transmitting a message responsive to the subsequent request that indicates, to the source, an authentication failure of the at least one other credential, where the message may be based on the deviation satisfying the threshold.

Some examples of the method, apparatuses, and non-transitory computer-readable medium described herein may further include operations, features, means, or instructions for transmitting a message that indicates, to a user of the software platform, a request to updated a credential, where the message may be based on the deviation satisfying the threshold, and where the credential includes the at least one credential used by the previous request or the at least one other credential used by the subsequent request.

Some examples of the method, apparatuses, and non-transitory computer-readable medium described herein may further include operations, features, means, or instructions for determining that a duration over which the device received the set of multiple requests from the source satisfies a request rate threshold, where restricting access to the one or more resources may be based on the duration satisfying the request rate threshold.

Some examples of the method, apparatuses, and non-transitory computer-readable medium described herein may further include operations, features, means, or instructions for determining that the previous request may be associated with an authentication success, where restricting access to the one or more resources may be based on receiving the subsequent request.

Some examples of the method, apparatuses, and non-transitory computer-readable medium described herein may further include operations, features, means, or instructions for storing, at the device, the at least one credential used by the previous request and the at least one other credential used by the subsequent request based on the deviation satisfying the threshold.

In some examples of the method, apparatuses, and non-transitory computer-readable medium described herein, the source includes a device associated with a device fingerprint or one or more devices associated with a same internet protocol address.

In some examples of the method, apparatuses, and non-transitory computer-readable medium described herein, the at least one credential used by the previous request and the at least one other credential used by the subsequent request each include one or both of a username and password.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing access requests at a device, comprising:
receiving, at a software platform of the device, a plurality of requests from a source to access one or more resources, wherein each request of the plurality of requests uses one or more credentials;
determining that a deviation between at least one credential used by a previous request of the plurality of requests and at least one other credential used by a subsequent request of the plurality of requests satisfies a threshold, wherein the threshold is based at least in part on the one or more resources; and
restricting access to the one or more resources based at least in part on the deviation satisfying the threshold.

2. The method of claim 1, further comprising:
determining a quantity of operations to perform on the at least one credential used by the previous request to obtain the at least one other credential used by the subsequent request, wherein the deviation comprises the quantity of operations.

3. The method of claim 2, wherein:
the at least one credential used by the previous request and the at least one other credential used by the subsequent request each comprise at least one sequence of elements, and
an operation of the quantity of operations corresponds to an element of a sequence of the at least one sequence of elements.

4. The method of claim 1, wherein determining that the deviation between the at least one credential used by the previous request and the at least one other credential used by the subsequent request satisfies the threshold comprises:
determining that the deviation between a portion of the at least one credential used by the previous request and a corresponding portion of the at least one other credential used by the subsequent request satisfies the threshold.

5. The method of claim 1, wherein determining that the deviation between the at least one credential used by the previous request and the at least one other credential used by the subsequent request satisfies the threshold comprises:
determining that the at least one other credential used by the subsequent request is unassociated with a set of credentials corresponding to the at least one credential used by the previous request.

6. The method of claim 1, further comprising:
determining that a feature flag associated with the threshold is enabled for the source, wherein determining that the deviation between the at least one credential used by the previous request and the at least one other credential used by the subsequent request satisfies the threshold is based at least in part on the feature flag being enabled.

7. The method of claim 1, wherein restricting access to the one or more resources comprises:
transmitting a message responsive to the subsequent request that indicates, to the source, an authentication failure of the at least one other credential, wherein the message is based at least in part on the deviation satisfying the threshold.

8. The method of claim 1, further comprising:
transmitting a message that indicates, to a user of the software platform, a request to updated a credential, wherein the message is based at least in part on the deviation satisfying the threshold, and wherein the credential comprises the at least one credential used by the previous request or the at least one other credential used by the subsequent request.

9. The method of claim 1, further comprising:
determining that a duration over which the device received the plurality of requests from the source satisfies a request rate threshold, wherein restricting access to the one or more resources is based at least in part on the duration satisfying the request rate threshold.

10. The method of claim 1, further comprising:
determining that the previous request is associated with an authentication success, wherein restricting access to the one or more resources is based at least in part on receiving the subsequent request.

11. The method of claim 1, further comprising:
storing, at the device, the at least one credential used by the previous request and the at least one other credential used by the subsequent request based at least in part on the deviation satisfying the threshold.

12. The method of claim 1, wherein the source comprises a device associated with a device fingerprint or one or more devices associated with a same internet protocol address.

13. The method of claim 1, wherein the at least one credential used by the previous request and the at least one other credential used by the subsequent request each comprise one or both of a username and password.

14. An apparatus for managing access requests at a device, comprising:
a processor;
memory coupled with the processor; and
instructions stored in the memory and executable by the processor to cause the apparatus to:
receive, at a software platform of the device, a plurality of requests from a source to access one or more resources, wherein each request of the plurality of requests uses one or more credentials;
determine that a deviation between at least one credential used by a previous request of the plurality of requests and at least one other credential used by a subsequent request of the plurality of requests satisfies a threshold, wherein the threshold is based at least in part on the one or more resources; and
restrict access to the one or more resources based at least in part on the deviation satisfying the threshold.

15. The apparatus of claim 14, wherein the instructions are further executable by the processor to cause the apparatus to:
determine a quantity of operations to perform on the at least one credential used by the previous request to obtain the at least one other credential used by the subsequent request, wherein the deviation comprises the quantity of operations.

16. The apparatus of claim 14, wherein the instructions to determine that the deviation between the at least one credential used by the previous request and the at least one other credential used by the subsequent request satisfies the threshold are executable by the processor to cause the apparatus to:
determine that the deviation between a portion of the at least one credential used by the previous request and a corresponding portion of the at least one other credential used by the subsequent request satisfies the threshold.

17. The apparatus of claim 14, wherein the instructions to determine that the deviation between the at least one credential used by the previous request and the at least one other credential used by the subsequent request satisfies the threshold are executable by the processor to cause the apparatus to:
determine that the at least one other credential used by the subsequent request is unassociated with a set of credentials corresponding to the at least one credential used by the previous request.

18. A non-transitory computer-readable medium storing code for managing access requests at a device, the code comprising instructions executable by a processor to:
receive, at a software platform of the device, a plurality of requests from a source to access one or more resources, wherein each request of the plurality of requests uses one or more credentials;
determine that a deviation between at least one credential used by a previous request of the plurality of requests and at least one other credential used by a subsequent request of the plurality of requests satisfies a threshold, wherein the threshold is based at least in part on the one or more resources; and
restrict access to the one or more resources based at least in part on the deviation satisfying the threshold.

19. The non-transitory computer-readable medium of claim 18, wherein the instructions are further executable by the processor to:
determine a quantity of operations to perform on the at least one credential used by the previous request to obtain the at least one other credential used by the subsequent request, wherein the deviation comprises the quantity of operations.

20. The non-transitory computer-readable medium of claim 18, wherein the instructions to determine that the deviation between the at least one credential used by the previous request and the at least one other credential used by the subsequent request satisfies the threshold are executable by the processor to:
determine that the deviation between a portion of the at least one credential used by the previous request and a corresponding portion of the at least one other credential used by the subsequent request satisfies the threshold.
